(19) United States
(12) Patent Application Publication
(10) Pub. No.: US 2023/0278868 A1
(43) Pub. Date: Sep. 7, 2023

(54) A CORAL-LIKE COMPOSITE MATERIAL AND A METHOD OF PREPARING THE SAME

(71) Applicant: Agency for Science, Technology and Research, Singapore (SG)

(72) Inventors: Jackie Y. YING, Singapore (SG); Jian Liang CHEONG, Singapore (SG)

(21) Appl. No.: 18/008,148

(22) PCT Filed: Jun. 2, 2021
(86) PCT No.: PCT/SG2021/050317

§ 371 Date: Dec. 2, 2022

(30) Foreign Application Priority Data
Jun. 2, 2020 (SG) 10202005210P

(51) Int. Cl. C01B 32/158; C01B 32/914; H01M 50/431; H01M 10/052; H01M 10/058; C01B 21/06; C01B 21/082

(52) U.S. Cl. CPC C01B 32/158; C01B 32/914; H01M 50/431; H01M 10/052; H01M 10/058; C01B 21/06; C01B 21/0828; H01M 2010/0495

(57) ABSTRACT

There is provided a coral-like composite material comprising highly dispersed conductive metal nitride, metal carbide or metal carbonitride nanoparticles on mesoporous carbon nanosheets, and a method of preparing the same. There is also provided a coating material for a modified separator of a lithium-sulfur battery comprising the coral-like composite material as described herein, a conducting carbon material and a binder, and a method of preparing the same.

### REFERENCES TO RELATED APPLICATIONS

This application claims priority to Singapore application number 10202005210P filed on 2 Jun. 2020, the disclosure of which is hereby incorporated by reference.

### TECHNICAL FIELD

The present invention relates to a coral-like composite material, a coating material and methods of preparing the same.

### BACKGROUND ART

Existing energy storage technologies (i.e. Li-ion battery (LIB)) are limited by energy density and cost.

Battery systems based on lithium-sulfur (Li—S) chemistry have high theoretical energy density (2600 Wh kg⁻¹), and are relatively inexpensive due to the high abundance of S. Hence, LSB is touted as one of the most promising technologies for energy storage. However, the commercialization of LSB technology has been hampered by problems of the sulfur cathode—(i) low sulfur utilization, resulting in lower than expected energy density, and (ii) high capacity fading, leading to short battery life span. The poor electrical conductivity of sulfur and its corresponding reduction product, Li₂S, result in low sulfur utilization and hence, low specific capacity. High capacity fading is due to sulfur loss from the diffusion of highly soluble PS intermediates to the lithium anode, known as the polysulfide (PS) shuttling effect, during electrochemical charging and discharging. Over the past decade, there has been significant progress towards understanding the underlying mechanisms of LSB system, leading to the development of various strategies such as better cathode nanostructures design and the use of different electrolyte and additives.

Although these strategies have resulted in high reversible specific capacities with excellent rate capabilities and capacity retention, the areal capacities are still too low to compete with the current LIB technology. An areal capacity of at least 4 mAh cm⁻² would be needed for LSB to be attractive. To achieve this, high areal sulfur loadings of at least 6 mg cm⁻² coupled with high sulfur utilization would be required. However, with the increase in areal loadings, the problems associated with the sulfur cathode (i.e. the poor electrical conductivity of sulfur and the PS shuttling effect) would be exacerbated. In the literature, high areal capacities at high sulfur loadings have been achieved by using an interlayer in between the sulfur cathode and the separator, which could minimize the PS shuttling effect via sequestration of PS by surface functional groups, and serve as nucleation sites for the electrochemical processes of LSB. Interlayer could be employed as an upper current collector coated over the sulfur cathode, as a free-standing structure inserted during battery preparation, or supported on a separator (i.e. as a modified separator). To date, carbon-based materials (such as carbon nanofibers, vapor-grown carbon fibers (VGCF) and graphene) and more recently, metal-organic frameworks (such as Ce-MOF-808 and Ni₃(HITP)₂) have been used as interlayer. Separators modified with inorganic compounds, such as metal oxides, nitrides, carbides, hydroxides and sulfides, have been demonstrated as effective PS barriers at low sulfur loadings. In particular, nitrides and carbides exhibited high electrical and chemical stability, which would help towards overcoming the problems associated with the sulfur cathode.

Despite the breakthroughs in lithium-sulfur batteries (LSB), sulfur (S) loadings are often too low to be practical. To meet or exceed the areal capacity of current lithium-ion batteries (4 mAh cm⁻²), higher sulfur loadings (>6 mg cm⁻²) with high specific capacities (>800 mAh g⁻¹) are necessary. However, increasing sulfur loadings in LSBs would exponentially exacerbate the inherent problems, such as polysulfide (PS) shuttling effect. The rational design and scalable synthesis of structures of high surface area, porosity and electrical conductivity with large number of polar PS adsorption sites would be paramount in the development of effective PS barriers for high sulfur loadings and practical LSB. Therefore, there is a need to provide a coral-like composite material, a coating material and methods of preparing the same that overcome or ameliorate one or more of the disadvantages mentioned above.

### SUMMARY

In one aspect, the present disclosure relates to a coral-like composite material comprising highly dispersed conductive metal nitride, metal carbide or metal carbonitride nanoparticles on mesoporous carbon nanosheets.

Advantageously, the coral-like composite material may be used in a modified separator for a lithium-sulfur battery to address the issue of polysulfide shutting effect due to its strong polysulfide adsorption capability and therefore to achieve high areal capacity at a sulfur loading more than 6 mg cm⁻². The particular structure and morphology of the coral-like composite material may result in high surface area of the modified separator and high activity of the lithium-sulfur battery due to the small size of the nanoparticles.

In another aspect, the present disclosure relates to a method for preparing a coral-like composite material comprising the steps of
a) mixing a mixture of a precursor of metal nitride, metal carbide or metal carbonitride material and a graphitic carbon nitride material; and
b) drying the mixture and heating solids obtained from dried mixture at a first elevated temperature for a first time period and at a second elevated temperature for a second time period in an inert atmosphere.

Advantageously, the method may produce a high surface area, porous coral-like composite material with highly dispersed conductive metal carbide, metal nitride or metal carbonitride nanoparticles as an effective polysulfide barrier with high polysulfide adsorption capabilities.

In another aspect, the present disclosure relates to a coral-like composite material prepared by the method as described herein.

In another aspect, the present disclosure relates to a coating material for a modified separator of a lithium-sulfur battery comprising the coral-like composite material as described herein, a conducting carbon material and a binder.

In another aspect, the present disclosure relates to a method for preparing a modified separator for lithium-sulfur battery comprising the steps of
a) mixing a mixture of the coral-like composite material as described herein, a conducting carbon material and a binder; and
b) coating the mixture on a porous and non-electrically-conductive membrane.

In another aspect, the present disclosure relates to a lithium-sulfur battery comprising the coating material as described herein.

Advantageously, the lithium-sulfur battery comprising the modified separator as described herein may have a reduced charge transfer resistance R_{CT} as characterized by electrochemical impedance spectroscopy (EIS) as compared to a lithum-sulfur battery with a unmodified separator. The reduced R_{CT} values after separator modification could be due to the high electrical conductivity of the metal carbide, metal nitride or metal carbonitride, which could enhance the surface charge transfer reactions for better electrochemical performance.

### Definitions

The following words and terms used herein shall have the meaning indicated:

The term “coral-like” refers to a type of structure and morphology of a material that resembles the structure and morphology of a coral. Such material comprises uniform, well-dispersed and interconnected pores, therefore has a high surface area to volume ratio.

The term “graphene” as used herein represents a two-dimensional allotrope of carbon in the form of a single layer of atoms with the carbon atoms arranged in a two-dimensional honeycomb lattice.

The term “reduced graphene oxide” is one form of graphene oxide that is processed by chemical, thermal and other methods in order to reduce the oxygen content.

The term “composite” as used herein represents material made from two or more constituent materials with significantly different physical or chemical properties that, when combined, produce the material. The individual components remain separate and distinct within the finished material.

Unless specified otherwise, the terms “comprising” and “comprise”, and grammatical variants thereof, are intended to represent “open” or “inclusive” language such that they include recited elements but also permit inclusion of additional, unrecited elements.

As used herein, the term “about”, in the context of concentrations of components of the formulations, typically means +/−5% of the stated value, more typically +/−4% of the stated value, more typically +/−3% of the stated value, more typically, +/−2% of the stated value, even more typically +/−1% of the stated value, and even more typically +/−0.5% of the stated value.

Throughout this disclosure, certain embodiments may be disclosed in a range format. It should be understood that the description in range format is merely for convenience and brevity and should not be construed as an inflexible limitation on the scope of the disclosed ranges. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Certain embodiments may also be described broadly and generically herein. Each of the narrower species and subgeneric groupings falling within the generic disclosure also form part of the disclosure. This includes the generic description of the embodiments with a proviso or negative limitation removing any subject matter from the genus, regardless of whether or not the excised material is specifically recited herein.

### DETAILED DISCLOSURE OF EMBODIMENTS

Exemplary, non-limiting embodiments of a coral-like composite material will now be disclosed.

The present disclosure relates to a coral-like composite material comprising highly dispersed conductive metal nitride, metal carbide or metal carbonitride nanoparticles on mesoporous carbon nanosheets.

The size of the metal nitride, metal carbide or metal carbonitride nanoparticles may be in the range of about 2 nm to about 20 nm, about 5 nm to about 20 nm, about 10 nm to about 20 nm, about 15 nm to about 20 nm, about 2 nm to about 15 nm, about 2 nm to about 10 nm, about 2 nm to about 5 nm.

The metal element from the metal nitride, metal carbide or metal carbonitride nanoparticles may be a transition metal element selected from groups 3, 4, 5, 6, 7, 8, 9, 10, 11 or 12 of the Periodic Table of Elements. Non-limiting examples of the transition metal include scandium, titanium, vanadium, chromium, manganese, iron, cobalt, nickel, copper, zinc, yttrium, zirconium, niobium, molybdenum, technetium, ruthenium, rhodium, palladium, silver, cadmium, hafnium, tantalum, tungsten, rhenium, osmium, iridium, platinum, or combinations thereof.

Non-limiting examples of the metal carbide may be niobium carbide, titanium carbide, tungsten carbide, molybdenum carbide, vanadium carbide, hafnium carbide, niobium titanium carbide, niobium tungsten carbide, niobium molybdenum carbide, niobium vanadium carbide, niobium hafnium carbide, titanium tungsten carbide, titanium molybdenum carbide, titanium vanadium carbide, titanium hafnium carbide, tungsten molybdenum carbide, tungsten vanadium carbide, tungsten hafnium carbide, molybdenum vanadium carbide, molybdenum hafnium carbide, vanadium hafnium carbide or their mixtures thereof. The metal carbide may preferably be niobium carbide.

Non-limiting examples of the metal nitride may be titanium nitride, tungsten nitride, molybdenum nitrides, vanadium nitrides, niobium nitride, zirconium nitride, hafnium nitride, titanium tungsten nitride, titanium molybdenum nitride, titanium vanadium nitride, titanium niobium nitride, titanium zirconium nitride, titanium hafnium nitride, tungsten molybdenum nitride, tungsten vanadium nitride, tungsten niobium nitride, tungsten zirconium nitride, tungsten hafnium nitride, molybdenum vanadium nitride, molybdenum niobium nitride, molybdenum zirconium nitride, molybdenum hafnium nitride, vanadium niobium nitride, vanadium zirconium nitride, vanadium hafnium nitride, niobium zirconium nitride, niobium hafnium nitride, zirconium hafnium nitride or their mixtures thereof. The metal nitride may preferably be titanium nitride.

Non-limiting examples of the metal carbonitride may be vanadium carbonitride, titanium carbonitride, tungsten carbonitride, molybdenum carbonitride, niobium carbonitride, zirconium carbonitride, vanadium titanium carbonitride, vanadium tungsten carbonitride, vanadium molybdenum carbonitride, vanadium niobium carbonitride, vanadium zirconium carbonitride, titanium tungsten carbonitride, titanium molybdenum carbonitride, titanium niobium carbonitride, titanium zirconium carbonitride, tungsten molybdenum carbonitride, tungsten niobium carbonitride, tungsten zirconium carbonitride, molybdenum niobium carbonitride, molybdenum zirconium carbonitride, niobium zirconium carbonitride or their mixtures thereof. The metal carbonitride may preferably be vanadium carbonitride.

When a combination of transition metals is present, the combination may include the transition metal dopant (or doping agent) in another transition metal that forms doped binary, ternary or quaternary metal carbide, metal nitride or metal carbonitride.

The metal carbide, metal nitride or metal carbonitride nanoparticles may further comprise surface metal oxides. The surface metal oxides may be amorphous. Advantageously, the surface metal oxides are beneficial to suppress polysulfide shutting since metal oxides have excellent polysulfide adsorption capabilities.

The coral-like composite material may have a surface area larger than 100 m²/g. The coral-like composite material may have a surface area in the range of about 100 m²/g to about 300 m²/g, about 125 m²/g to about 300 m²/g, about 150 m²/g to about 300 m²/g, about 175 m²/g to about 300 m²/g, about 200 m²/g to about 300 m²/g, about 225 m²/g to about 300 m²/g, about 250 m²/g to about 300 m²/g, about 275 m²/g to about 300 m²/g, about 100 m²/g to about 275 m²/g, about 100 m²/g to about 250 m²/g, about 100 m²/g to about 225 m²/g, about 100 m²/g to about 200 m²/g, about 100 m²/g to about 175 m²/g, about 100 m²/g to about 150 m²/g or about 100 m²/g to about 125 m²/g.

The coral-like composite material may have a pore volume in the range of about 0.5 cm³/g to about 2 cm³/g, about 0.7 cm³/g to about 2 cm³/g, about 0.9 cm³/g to about 2 cm³/g, about 1.1 cm³/g to about 2 cm³/g, about 1.2 cm³/g to about 2 cm³/g, about 1.4 cm³/g to about 2 cm³/g, about 1.6 cm³/g to about 2 cm³/g, about 1.8 cm³/g to about 2 cm³/g, about 0.5 cm³/g to about 1.8 cm³/g, about 0.5 cm³/g to about 1.6 cm³/g, about 0.5 cm³/g to about 1.4 cm³/g, about 0.5 cm³/g to about 1.2 cm³/g, about 0.5 cm³/g to about 1.1 cm³/g, about 0.5 cm³/g to about 0.9 cm³/g or about 0.5 cm³/g to about 0.7 cm³/g.

The coral-like composite material may have a pore size in the range of about 2 nm to about 50 nm, about 5 nm to about 50 nm, about 10 nm to about 50 nm, about 15 nm to about 50 nm, about 20 nm to about 50 nm, about 25 nm to about 50 nm, about 30 nm to about 50 nm, about 35 nm to about 50 nm, about 40 nm to about 50 nm, about 45 nm to about 50 nm, about 2 nm to about 45 nm, about 2 nm to about 40 nm, about 2 nm to about 35 nm, about 2 nm to about 30 nm, about 2 nm to about 25 nm, about 2 nm to about 20 nm, about 2 nm to about 15 nm, about 2 nm to about 10 nm or about 2 nm to about 5 nm.

Exemplary, non-limiting embodiments of a method for preparing a coral-like composite material will now be disclosed.

The present disclosure relates to a method for preparing a coral-like composite material comprising the steps of
a) mixing a mixture of a precursor of metal nitride, metal carbide or metal carbonitride material and a graphitic carbon nitride material; and
b) drying the mixture and heating solids obtained from dried mixture at a first elevated temperature for a first time period and at a second elevated temperature for a second time period in an inert atmosphere.

The precursor of the metal nitride metal carbide or metal carbonitride material may be metal alkoxide. The metal may be a transition metal element selected from groups 3, 4, 5, 6, 7, 8, 9, 10, 11 or 12 of the Periodic Table of Elements. Non-limiting examples of the transition metal include scandium, titanium, vanadium, chromium, manganese, iron, cobalt, nickel, copper, zinc, yttrium, zirconium, niobium, molybdenum, technetium, ruthenium, rhodium, palladium, silver, cadmium, hafnium, tantalum, tungsten, rhenium, osmium, iridium, platinum, or combinations thereof.

When a combination of transition metals is present, the combination may include the transition metal dopant (or doping agent) in another transition metal that forms doped binary, ternary or quaternary metal carbide, metal nitride or metal carbonitride.

Non-limiting examples of the precursor of the metal nitride, metal carbide or metal carbonitride material include niobium(V) ethoxide, niobium(V) chloride, vanadium(V) oxytriethoxide, vanadium (V) tri-i-propoxy oxide vanadium(III) chloride, vanadium(IV)-oxy acetylacetonate, vanadium(V) oxychloride, titanium(IV) isopropoxide, titanium(IV) ethoxide, titanium(V) butoxide, iron(II) chloride, iron(III) chloride, iron(II) methoxide, iron(III) ethoxide, iron(II) acetylacetonate, iron(III) acetylacetonate, tin (II) chloride, dibutyltin dilaureate, nickel(II) chloride, nickel(II) ethoxide, nickel(II) acetylacetonate, cobalt(II) chloride, cobalt(II) methoxide, cobalt(II) acetylacetonate, manganese(II) chloride, manganese(II) methoxide, manganese(II) acetylacetonate, zirconium(IV) chloride, zirconium(IV) propoxide or combinations thereof.

The precursor of the metal nitride may preferably be titanium(IV) butoxide (Ti(OBu)₄). The precursor of the metal carbide may preferably be niobium(V) ethoxide (Nb(OEt)₅). The precursor of the metal nitride may preferably be vanadium(V) oxytriethoxide (VO(OEt)₃).

The graphitic carbon nitride material may have a surface area in the range of about 40 m²/g to about 250 m²/g, about 50 m²/g to about 250 m²/g, about 60 m²/g to about 250 m²/g, about 70 m²/g to about 250 m²/g, about 100 m²/g to about 250 m²/g, about 150 m²/g to about 250 m²/g, about 200 m²/g to about 250 m²/g, about 40 m²/g to about 200 m²/g, about 40 m²/g to about 150 m²/g, about 40 m²/g to about 100 m²/g, about 40 m²/g to about 70 m²/g, about 40 m²/g to about 60 m²/g or about 40 m²/g to about 50 m²/g.

The graphitic carbon nitride material may have a pore volume in the range of about 0.1 cm³/g to about 0.5 cm³/g, about 0.15 cm³/g to about 0.5 cm³/g, about 0.2 cm³/g to about 0.5 cm³/g, about 0.25 cm³/g to about 0.5 cm³/g, about 0.3 cm³/g to about 0.5 cm³/g, about 0.35 cm³/g to about 0.5 cm³/g, about 0.4 cm³/g to about 0.5 cm³/g, about 0.45 cm³/g to about 0.5 cm³/g, about 0.1 cm³/g to about 0.45 cm³/g, about 0.1 cm³/g to about 0.4 cm³/g, about 0.1 cm³/g to about 0.35 cm³/g, about 0.1 cm³/g to about 0.3 cm³/g, about 0.1 cm³/g to about 0.25 cm³/g, about 0.1 cm³/g to about 0.2 cm³/g or about 0.1 cm³/g to about 0.15 cm³/g.

The graphitic carbon nitride material may have a pore size in the range of about 2 nm to about 60 nm, about 5 nm to about 60 nm, about 10 nm to about 60 nm, about 15 nm to about 60 nm, about 20 nm to about 60 nm, about 25 nm to about 60 nm, about 30 nm to about 60 nm, about 35 nm to about 60 nm, about 40 nm to about 60 nm, about 45 nm to about 60 nm, about 50 nm to about 60 nm, about 55 nm to about 60 nm, about 2 nm to about 55 nm, about 2 nm to about 50 nm, about 2 nm to about 45 nm, about 2 nm to about 40 nm, about 2 nm to about 35 nm, about 2 nm to about 30 nm, about 2 nm to about 25 nm, about 2 nm to about 20 nm, about 2 nm to about 15 nm, about 2 nm to about 10 nm or about 2 nm to about 5 nm.

The graphitic carbon nitride may be prepared by a method comprising the steps of
i) heating urea at about 400° C. to about 600° C. for more than 3 hours; and
ii) drying the heated products at about 100° C. to about 200° C. overnight under vacuum.

Advantageously, the method to prepare the graphitic carbon nitride is scalable due to the use of urea, which is readily available and has low cost.

The drying of step ii) is to remove the water content from the graphitic carbon nitride since the precursor of the metal carbide, metal nitride or metal carbonitride may be moisture sensitive.

The graphitic carbon nitride material needs to be well-dispersed in order for maximal interaction with the precursor of the metal carbide, metal nitride or metal carbonitride. The mixing step a) may be done in an organic polar solvent. Non-limiting examples of the organic polar solvent include tetrahydrofuran (THF), lower alcohols or acetonitrile. Non-limiting examples of the lower alcohols may be methanol, ethanol, propan-1-ol, 2-methylpropan-1-ol, propan-2-ol, butan-2-ol, pent-3-ol, 2-methylpropan-2-ol, 2-methylbutan-2-ol, butan-lol.

The drying step of step b) may comprise the step of removing the solvent using a rotary evaporator under reduced pressure. The drying step of step b) may further comprise a drying step under high vacuum overnight to remove the residue solvent before the heating step.

The first elevated temperature of step b) may be in the range of about 400° C. to about 700° C., about 450° C. to about 700° C., about 500° C. to about 700° C., about 550° C. to about 700° C., about 600° C. to about 700° C., about 650° C. to about 700° C., about 400° C. to about 650° C., about 400° C. to about 600° C., about 400° C. to about 550° C., about 400° C. to about 500° C. or about 400° C. to about 450° C.

The first time period of step b) may be more than 3 hours. The first time period of step b) may be in the range of about 3.5 hours to about 10 hours, about 4 hours to about 10 hours, about 5 hours to about 10 hours, about 6 hours to about 10 hours, about 7 hours to about 10 hours, about 8 hours to about 10 hours, about 9 hours to about 10 hours, about 3.5 hours to about 9 hours, about 3.5 hours to about 8 hours, about 3.5 hours to about 7 hours, about 3.5 hours to about 6 hours, about 3.5 hours to about 5 hours or about 3.5 hours to about 4 hours.

The second elevated temperature of step b) may be in the range of about 750° C. to about 1000° C., about 800° C. to about 1000° C., about 850° C. to about 1000° C., about 900° C. to about 1000° C., about 950° C. to about 1000° C., about 750° C. to about 950° C., about 750° C. to about 900° C., about 750° C. to about 850° C. or about 750° C. to about 800° C.

The second time period of step b) may be more than 2 hours. The second time period of step b) may be in the range of about 2.5 hours to about overnight, about 3 hours to about overnight, about 4 hours to about overnight, about 5 hours to about overnight, about 6 hours to about overnight, about 7 hours to about overnight, about 2.5 hours to about 7 hours, about 2.5 hours to about 7 hours, about 2.5 hours to about 6 hours, about 2.5 hours to about 5 hours, about 2.5 hours to about 4 hours or about 2.5 hours to about 3 hours.

The heating step at the first elevated temperature is to allow sufficient time for crystalline phase formation of the metal carbide, metal nitride or metal carbonitride material. The heating step at the second elevated temperature is to ensure that the carbon nitride material is decomposed and to graphitize amorphous carbon.

The heating step may be done in a furnace. The inert atmosphere may be under Argon.

The method may further comprise, after step (b), a passivating step of introducing nitrogen at a flow rate of about 400 mL/min to about 600 mL/min for more than 1 hours followed by introducing air at a flow rate of about 30 mL/min to about 70 mL/min for more than 3 hours after the furnace is cooled to room temperature.

Advantageously, surface passivation may result in the formation of surface metal oxides, which may prevent sudden oxidation of the reactive metal carbide, metal nitride or metal carbonitride material, which may destroy the structure of the coral-like composite material.

The present disclosure relates to a coral-like composite material prepared by the method as described herein.

The present disclosure relates to a coating material for a modified separator of a lithium-sulfur battery comprising the coral-like composite material as described herein, a conducting carbon material and a binder.

The coral-like composite material may have a weight percentage in the range of about 45 wt % to about 90 wt %, about 50 wt % to about 90 wt %, about 55 wt % to about 90 wt %, about 60 wt % to about 90 wt %, about 65 wt % to about 90 wt %, about 70 wt % to about 90 wt %, about 75 wt % to about 90 wt %, about 80 wt % to about 90 wt %, about 85 wt % to about 90 wt %, about 45 wt % to about 85 wt %, about 45 wt % to about 80 wt %, about 45 wt % to about 75 wt %, about 45 wt % to about 70 wt %, about 45 wt % to about 65 wt %, about 45 wt % to about 60 wt %, about 45 wt % to about 55 wt % or about 45 wt % to about 50 wt % based on the total weight of the coating material.

The conducting carbon material may be selected from the group consisting of reduced graphene oxide, graphene, graphite, carbon nanotube, carbon fiber, acetylene black, and ketjenblack. The conducting carbon material may have a diameter in the range of about 0.1 nm to about 100 μm, about 1 nm to about 100 μm, about 10 nm to about 100 μm, about 100 nm to about 100 μm, about 1 μm to about 100 μm, about 10 μm to about 100 μm, about 0.1 nm to about 10 μm, about 0.1 nm to about 1 μm, about 0.1 nm to about 100 nm, about 0.1 nm to about 10 nm, about 0.1 nm to about 1 nm. The conducting carbon material may be vapor grown carbon fiber (VGCF).

The conducting carbon material may have a weight percentage in the range of about 10 wt % to about 40 wt %, about 15 wt % to about 40 wt %, about 20 wt % to about 40 wt %, about 25 wt % to about 40 wt %, about 30 wt % to about 40 wt %, about 35 wt % to about 40 wt %, about 10 wt % to about 35 wt %, about 10 wt % to about 30 wt %, about 10 wt % to about 25 wt %, about 10 wt % to about 20 wt % or about 10 wt % to about 15 wt % based on the total weight of the coating material. Advantageously, the conducting carbon material may enhance the mechanical stability of the coating material.

The binder may be polyethylene oxide (PEO) or other binders commonly used for a lithium-sulfur battery. The binder may be water soluble. The binder may be a water-soluble polymeric binder. The molecular weight of the polyethylene oxide may be in the range of about 5×10³ g/mol to about 5×10⁶ g/mol, about 5×10⁴ g/mol to about 5×10⁶ g/mol, about 5×10⁵ g/mol to about 5×10⁶ g/mol, about 5×10³ g/mol to about 5×10⁵ g/mol or about 5×10³ g/mol to about 5×10⁴ g/mol. The binder may have a weight percentage in the range of about 5 wt % to about 15 wt %, about 10 wt % to about 15 wt % or about 5 wt % to about 10 wt % based on the total weight of the coating material. Advantageously, the binder may impart mechanical strength to the coating layer. Further advantageously, the binder may enhance lithium ion conducting properties. Still advantageously, the binder may be used as a dispersant to improve the dispersity and homogeneity of the coating material.

The coating material may have a thickness in the range of about 5 μm to about 70 μm, about 10 μm to about 70 μm, about 15 μm to about 70 μm, about 20 μm to about 70 μm, about 25 μm to about 70 μm, about 30 μm to about 70 μm, about 35 μm to about 70 μm, about 40 μm to about 70 μm, about 45 μm to about 70 μm, about 50 μm to about 70 μm, about 55 μm to about 70 μm, about 60 μm to about 70 μm, about 65 μm to about 70 μm, about 5 μm to about 65 μm, about 5 μm to about 60 μm, about 5 μm to about 55 μm, about 5 μm to about 50 μm, about 5 μm to about 45 μm, about 5 μm to about 40 μm, about 5 μm to about 35 μm, about 5 μm to about 30 μm, about 5 μm to about 25 μm, about 5 μm to about 20 μm, about 5 μm to about 15 μm or about 5 μm to about 10 μm.

The coating material may have a mass density in the range of about 0.5 mg cm⁻² to about 3 mg cm⁻, about 1 mg cm⁻² to about 3 mg cm⁻², about 1.5 mg cm⁻² to about 3 mg cm⁻², about 2 mg cm⁻² to about 3 mg cm⁻, about 2.5 mg cm⁻² to about 3 mg cm⁻, about 0.5 mg cm⁻² to about 2.5 mg cm⁻, about 0.5 mg cm⁻² to about 2 mg cm⁻², about 0.5 mg cm⁻² to about 1.5 mg cm⁻² or about 0.5 mg cm⁻² to about 1 mg cm⁻².

The present disclosure relates to a method for preparing a modified separator for lithium-sulfur battery comprising the steps of
a) mixing a mixture of the coral-like composite material as described herein, a conducting carbon material and a binder; and
b) coating the mixture on a porous and non-electrically-conductive membrane.

The mixing step a) may be done in an organic solvent. The mixing step a) may be done in water. The mixing step a) may be done in a mixture of water and an organic solvent. The organic solvent may be absolute ethanol, N-methyl-2-pyrrolidone, isopropyl alcohol, butanol or their mixtures thereof. The mixing step a) may be done by stirring or ball milling. Sonication may be applied during the mixing step to improve the homogeneity of the mixture.

The conducting carbon material may be selected from the group consisting of reduced graphene oxide, graphene, graphite, carbon nanotube, carbon fiber, acetylene black, and ketjenblack. The reduced graphene oxide may be doped with nitrogen, boron, phosphorus, sulfur or their mixtures thereof. The carbon nanotube may be functionalized with non-limiting examples of —OH, —COOH, —NH₂, —SH or —SO₂H.

The porous and non-electrically-conductive membrane may be a glass fiber membrane, a polypropylene and/or a polyethylene electrolytic membrane. The porous and non-electrically-conductive membrane may be a polypropylene and/or a polyethylene electrolytic membrane, an example of which is a Celgard membrane from Celgard LLC.

The coating step b) may be performed by filtering the mixture through the porous and non-electrically conductive membrane.

The method may further comprise, after step b), a drying step under vacuum overnight.

The present disclosure relates to a lithium-sulfur battery comprising the coating material as described herein.

Advantageously, the lithium-sulfur battery comprising the modified separator as described herein shows specific and areal capacities as high as 1051 mAh g⁻¹ and 6.73 mAh cm⁻² respectively at 0.2 C and a high sulfur loading of 6-7 mg cm⁻², well surpassing the current LIB technology (˜160 mAh g⁻¹ and 4 mAh cm⁻², respectively). In contrast, a lithium-sulfur battery with an unmodified separator shows very low initial specific and areal capacities of only 401 mAh g⁻¹ and 2.65 mAh cm⁻² respectively. An excellent capacity retention of 91.1% is also obtained for the lithium-sulfur battery comprising the modified separator as described herein.

### BRIEF DESCRIPTION OF DRAWINGS

The accompanying drawings illustrate a disclosed embodiment and serves to explain the principles of the disclosed embodiment. It is to be understood, however, that the drawings are designed for purposes of illustration only, and not as a definition of the limits of the invention.

FIG. 1 is a schematic diagram showing the synthesis of coral-like nanomaterials and preparation of modified separator.

FIG. 2 shows XRD patterns of the coral-like nanomaterials (a) TiN/C, (b) V₂CN/C, and (c) NbC/C.

FIG. 3 shows (a) nitrogen adsorption-desorption isotherm and (b) B.J.H. desorption pore size distribution of TiN/C, V₂CN/C, NbC/C, and g-C₃N₄ template.

FIG. 4 shows a number of transmission electron microscopy (TEM) images of (a) g-C₃N⁴, (b) TiN/C, (c) V₂CN/C, and (d) NbC/C.

FIG. 5 shows TEM images (top) and HR-TEM (bottom) images of (a) TiN/C, (b) V₂CN/C, and (c) NbC/C.

FIG. 6 shows (a) UV-vis spectrum of 2 mM Li₂S₄ solution before, and after LiPS adsorption with TiN/C, V₂CN/C and NbC/C. (b, c, d) XPS spectra (top) before and (bottom) after LiPS adsorption.

FIG. 7 shows Raman spectrum of TiN/C, V₂CN/C and NbC/C. D band at 1356 cm⁻¹ and G band at 1583 cm⁻¹ are associated with disorder and graphitic nature of carbon, respectively.

FIG. 8 shows (a) XPS spectrum, and (b) Ti 2p, (c) N 1s, (d) C 1s and (e) O 1s core scans of TiN/C.

FIG. 9 shows (a) XPS spectrum, and (b) V 2p, (c) N 1s, (d) C 1s and (e) O 1s core scans of V₂CN/C.

FIG. 10 shows (a) XPS spectrum, and (b) Nb 3d, (c) N 1s, (d) C 1s and (e) O 1s core scans of NbC/C.

FIG. 11 shows calibration curve for Li₂S₄ solution at a wavelength of 320 nm.

FIG. 12 shows XPS S2p spectra of PS adsorbed on coral-like nanomaterials, (a) Li₂S₄—TiN/C, (b) Li₂S₄—V₂CN/C, (c) Li₂S₄—NbC/C and (d) pure Li₂S₄.

FIG. 13 shows (a) CV of cycled cells with unmodified separator, and separators modified with TiN/C, V₂CN/C and NbC/C. Arrows indicating redox onset potentials. (b) Nyquist plots of cycled cells with unmodified separator, and separators modified with TiN/C, V₂CN/C and NbC/C. Inset: high-frequency region with electrochemically fitted circuit.

FIG. 14 shows (a) rate capability studies of cells containing unmodified separator, and separators modified with TiN/C, V₂CN/C and NbC/C at various C rates. (b) First discharge cycle of cells containing unmodified separator, and separators modified with TiN/C, V₂CN/C and NbC/C at 0.05 C.

FIG. 15 shows (a,b) long-term cycling performance of cells with unmodified separator, and separators modified with TiN/C, V₂CN/C and NbC/C at 0.2 C. (c) Q_{H} analysis of cells containing separators modified with TiN/C, V₂CN/C and NbC/C at 0.2 C.

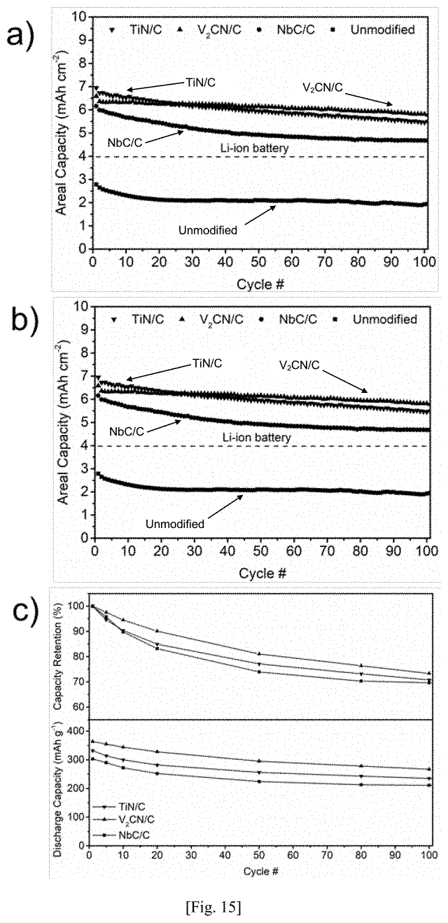

### DETAILED DESCRIPTION OF FIGURES

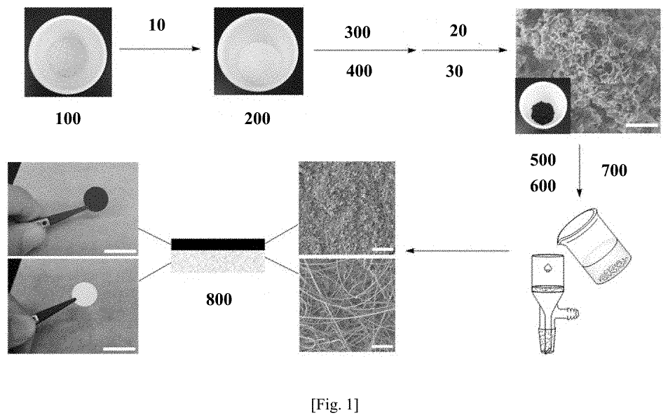

As shown in FIG. 1, according to this disclosure, there is provide a precursor of a graphitic carbon nitride material 100, which was subjected to a heating step 10 at a temperature (for example, at 500° C.) for a period of time (for example, of 3 hours). A graphitic carbon nitride material 200 was obtained and was then mixed with metal alkoxides 300 in a solvent 400. The mixture was then subjected to a heating step 20 at a first elevated temperature (for example, at 650° C.) for a period of time (for example, of 4 hours) and at a second elevated temperature (for example, at 800° C.) for a period of time (for example, at 3 hours) in an inert atmosphere 30. The obtained solid was mixed with a conducting carbon material 500 and a binder 600 in a solvent 700, and the mixture was filtered through a glass fiber membrane to obtain a modified separator 800.

### EXAMPLES

Non-limiting examples of the invention will be further described in greater detail by reference to specific Examples, which should not be construed as in any way limiting the scope of the invention.

### Example 1: Synthesis of the Coral-Like Nanomaterials

Urea was purchased from Sigma-Aldrich Pte. Ltd. (Singapore). Urea (30 g) was placed in a covered alumina crucible and heated to 500° C. in a muffle furnace in air for 4 hours to obtain yellow graphitic carbon nitride (g-C₃N⁴). g-C₃N₄(2 g) was dried in a 250-mL Schlenk flask overnight at 150° C. under vacuum. After cooling down to room temperature, anhydrous tetrahydrofuran (30 mL) was added into the flask and stirred for 30 minutes.

Precursors Ti(OnBu)₄, VO(OEt)₃ or Nb(OEt)₅ and Tetrahydrofuran (THF) were purchased from Sigma-Aldrich Pte Ltd. (Singapore). Ti(OnBu)₄, VO(OEt)₃ or Nb(OEt)₅ (5 mmol) were added dropwise to the g-C₃N₄/THF mixture under vigorous stirring, after which the mixture was further stirred for 30 minutes in a glovebox before solvent removal using a rotary evaporator under reduced pressure. Next, the solids were dried under high vacuum overnight before transferring to an alumina boat, which was then covered with a flat quartz plate and secured at both ends using copper wires. The boat was then placed inside a tube furnace, and heated under an argon flow (500 mL/min) at 650° C. for 4 hours (ramp rate: 2° C./min), followed by 800° C. for 3 hours (ramp rate: 1° C./min). The furnace was then allowed to cool down to room temperature. While maintaining an argon flow at a rate of 500 mL/min, passivation was conducted by first introducing nitrogen at a flow rate of 500 mL/min for 2 hours, followed by introducing air at a flow rate of 50 mL/min for 4 hours. 400-500 mg of black solids were obtained.

### Example 2: Preparation of Sulfur Cathode

Cathodes were prepared via a two-step procedure involving scaffold formation, followed by vapor-phase sulfur deposition. Vapor grown carbon fiber was purchased from Beijing DK Nanotechnology Co. Ltd. (China) Graphitized carbon nanotube and LA-132 were purchased from XF nano Co. Ltd (China) and Chengdu Indigo Power Sources Co. Ltd (China), respectively. An aqueous slurry mixture of VGCF, graphitized carbon nanotube and LA-132 was prepared in a 60:30:10 weight ratio and casted on a carbon-coated aluminum foil. After drying at 60° C. for 4 hours, the carbon scaffold was punched into circular disks of 10 mm in diameter. The weight of each scaffold was 6.2 to 6.8 mg. Next, the scaffold was placed on a stainless steel mesh of about 1 mm above a heated S reservoir (175° C.) for about 25 minutes to obtain 5.2 to 5.7 mg of loaded S corresponding to a loading density of 6.0 to 7.0 mg S per cm².

### Example 3: Preparation of Modified Separator

PEO binder was purchased from Sigma-Aldrich Pte. Ltd. (Singapore).. TiN/C, V₂CN/C or Nb₂CN/C (12 mg), VGCF (4 mg) and PEO (Mᵥ of about 5×10⁶, 1 wt %, 200 μL) were dispersed in absolute ethanol (100 mL) under sonication for 30 minutes. Next, the dispersion was poured directly through a glass fiber membrane (GF/A, Whatman, 47 mm) under suction, dried under vacuum overnight, and chopped into circular disks of 16.2 mm to obtain the modified separator. The average thickness and mass density of the coating were about 50 μm and about 1.5 mg cm², respectively.

### Example 4: Preparation of the Modified Separator and Battery Cells

Sublimed sulfur (S), lithium sulfide (Li₂S), dimethoxyethane (DME) were purchased from Sigma-Aldrich Pte. Ltd. (Singapore). Li₂S₄ solution (2 mM) was prepared in a glovebox by adding Li₂S and S₈ in appropriate amounts to 1,2-dimethoxyethane (DME) and subjected to overnight stirring at 50° C. Li₂S₄ solution (4 mL) was added to TiN/C, V₂CN/C or Nb₂CN/C (5 mg) and stirred overnight. The supernatant obtained via centrifugation was analyzed using UV-visible spectrophotometer. Residues were washed with DME and dried before XPS analysis.

### Example 5: Characterization

Materials were characterized by field emission SEM (JEOL JSM-7400F), TEM (FEI Tecnai F20), energy-dispersive X-ray spectrometry (Oxford X-MaxN), XRD (Bruker D8 ADVANCE), thermogravimetric analysis (PerkinElmer Pyris 1 TGA), inductively-coupled plasma (ICP) optical-emission spectroscopy (PerkinElmer Optima 5300DV) and elemental analysis (Thermo Flashsmart elemental analyzer (CHNS)). Nitrogen adsorption-desorption isotherms at −196° C. were collected using Micromeritics ASAP 2460 physisorption analyzer. Samples (˜60 mg) were degassed at 120° C. for 12 hours before measurement. Specific surface areas were calculated using the BET (Brunauer-Emmet-Teller) method. Pore size distributions (PSD) were obtained by the Barrett, Joyner, and Halenda (BJH) method using the cylindrical pore model. XPS measurements were obtained using PHI Quantera SXM Scanning X-ray Microprobe with a Al Kα X-ray source, and the signals were collected at a take-off angle of 45°. XPS spectral fitting was done using the CasaXPS software. UV-vis spectra were obtained for 250-500 nm at a resolution of 1 nm using a Biotek Cytation 5 imaging reader with a sealed quartz. Raman spectroscopy was performed on a Horiba Jobin Yvon Modular Raman Spectrometer using an argon-ion laser at 514 nm calibrated with a silicon reference.

X-Ray Diffraction (XRD)

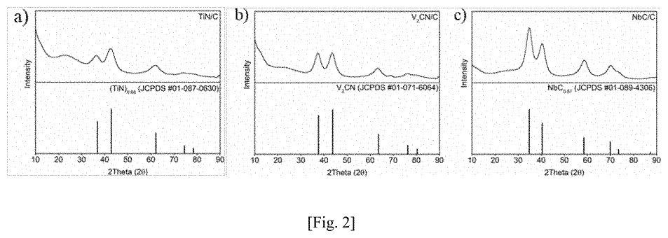

To determine the crystal phase and purity of the coral-like nanomaterials, X-ray diffraction (XRD) studies were conducted. XRD analysis revealed that the nanomaterials consisted of a single, pure phase of cubic (TiN)_{0.88}, V₂CN and NbC_{0.87}, respectively (FIG. 2). Applying Scherrer's formula to the (200) planes, the average crystallite sizes were calculated to be 3.1, 4.0 and 4.1 nm, respectively for TiN, V₂CN and NbC.

Nitrogen Adsorption-Desorption Analysis

The surface area and pore volume of these coral-like nanomaterials were found to be much higher than its urea-derived g-C₃N₄ template, which decomposed during heat treatment (Table 1).

TABLE 1
Surface area, pore volume and pore size
of the coral-like nanomaterials.

| | Surface Area | Pore Volume | Pore Size |
|---|---|---|---|
| Material | [m²/g]^{a} | [cm³/g]^{b} | [nm]^{c} |
| g-C₃N₄ | 54 | 0.19 | 40.3 |
| TiN/C | 277 | 1.15 | 34.2 |
| V₂CN/C | 240 | 1.11 | 30.1 |
| NbC/C | 174 | 0.84 | 34.9 |

^{a}Calculated using Brunauer-Emmet-Teller (B. E. T.) method.
^{b}Obtained at P/P₀ = 0.988.
^{c}Determined at the peak of the Barrett-Joyner-Halenda (B. J. H.) pore size distribution.

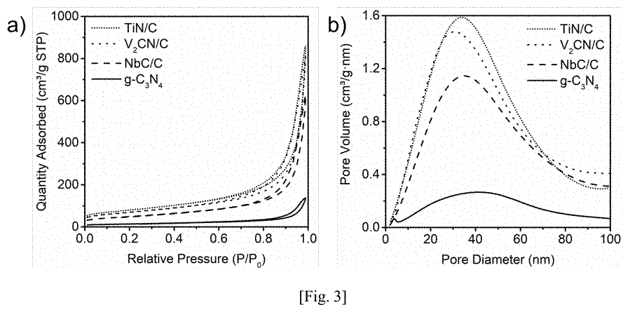

Nitrogen adsorption-desorption analysis of the coral-like nanomaterials revealed a type III isotherm with H3 hysteresis loop (FIG. 3a). Pore sizes of TiN/C, V₂CN/C and NbC/C were smaller than that of the g-C₃N₄ template, suggested that the metal alkoxides were impregnated within the template pores during synthesis (FIG. 3b).

Scanning Electron Microscopy (SEM) and Transmission Electron Microscopy (TEM)

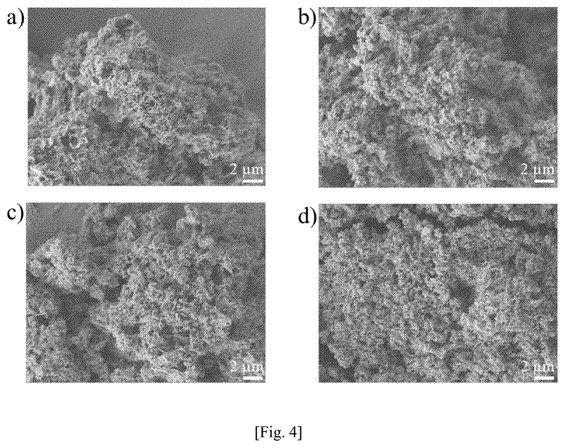

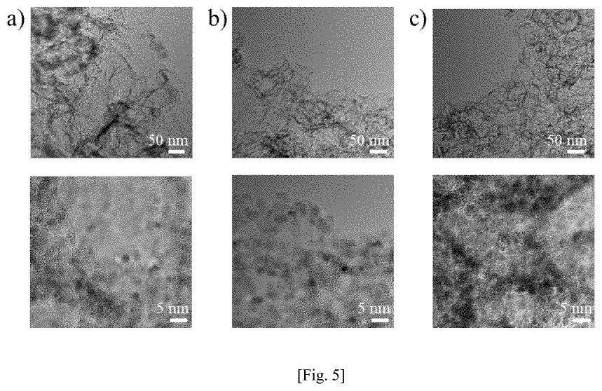

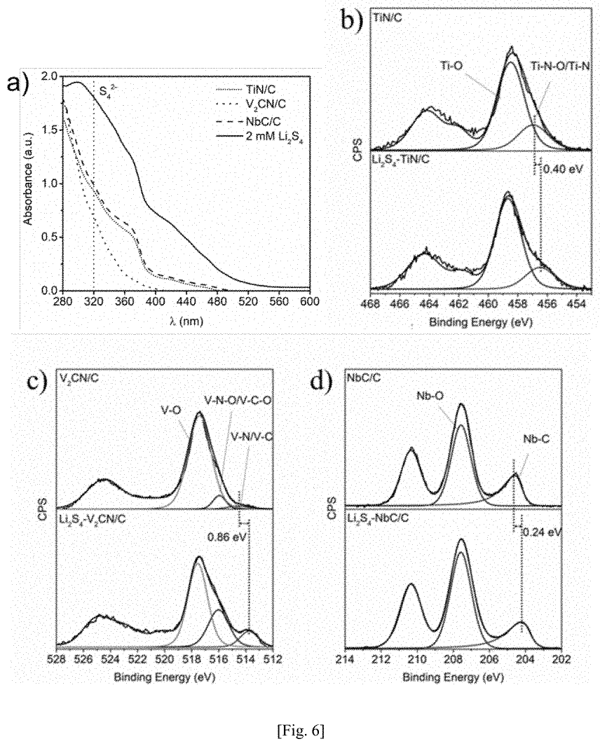

The particle morphology and nanostructure were examined using scanning electron microscopy (SEM) and transmission electron microscopy (TEM), respectively. SEM showed that TiN/C, V₂CN/C and NbC/C have the similar coral-like structure of g-C₃N₄(FIG. 4). TEM revealed that these coral-like nanomaterials consisted of a high dispersion of nanoparticles on a sheet-like carbon structure (FIG. 5). High-resolution TEM (HR-TEM) further confirmed that these nanoparticles were 3 to 4 nm in size, which agreed well with the average crystallite sizes calculated from XRD peak widths. The presence of carbon was confirmed by broad XRD peak at 2θ of about 220 (002 plane of graphite), Raman spectroscopy and elemental analysis (FIG. 1 and FIG. 6, Table 2).

TABLE 2
Elemental analysis of g-C₃N₄, TiN/C, V₂CN/C and NbC/C.

| Material | C (wt %)^{a} | H (wt %)^{a} | N (wt %)^{a} | Metal (wt %)^{b} |
|---|---|---|---|---|
| g-C₃N₄ | 33.3 | 1.9 | 58.6 | — |
| TiN/C | 36.9 | 0.6 | 10.9 | Ti, 34.2 |
| V₂CN/C | 35.5 | 0.6 | 5.3 | V, 41.5 |
| NbC/C | 22.4 | 0.3 | 2.3 | Nb, 62.2 |

^{a}CHNS analysis.
^{b}ICP analysis.

X-Ray Photoelectron Spectroscopy (XPS) and UV-Vis Spectroscopy

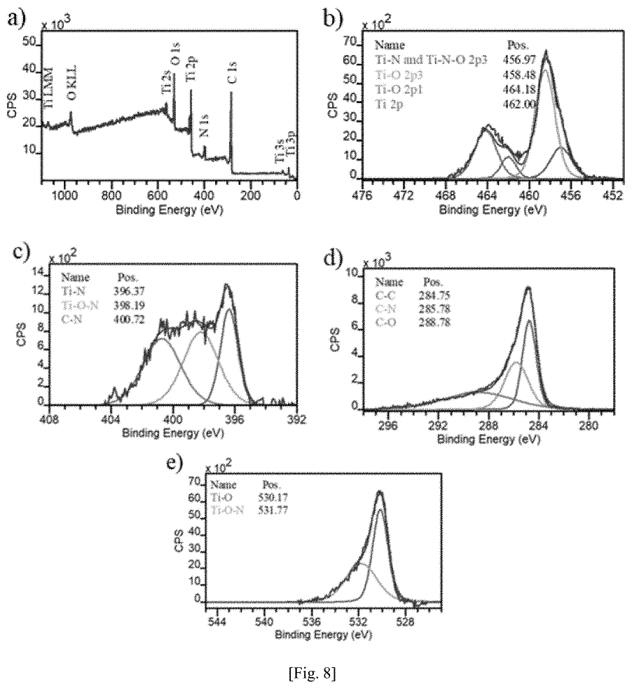

XPS revealed the rich surface bonding of the coral-like nanomaterials (FIG. 8 to FIG. 10). In general, the presence of XPS signals assigned to C—N, N—O, C—O bonds were likely to be due to unreacted g-C₃N₄ template or surface passivation in air. Surface passivation also resulted in the formation of metal oxide bonds, which were confirmed by the high intensity Ti—O, V—O and Nb—O XPS signals in TiN/C, V₂CN/C and NbC/C, respectively. These metal oxides were amorphous since no crystalline oxide phases were detected by XRD (FIG. 2). The presence of surface metal oxides might be beneficial to suppressing PS shuttling since metal oxides are known to have excellent PS adsorption capabilities.

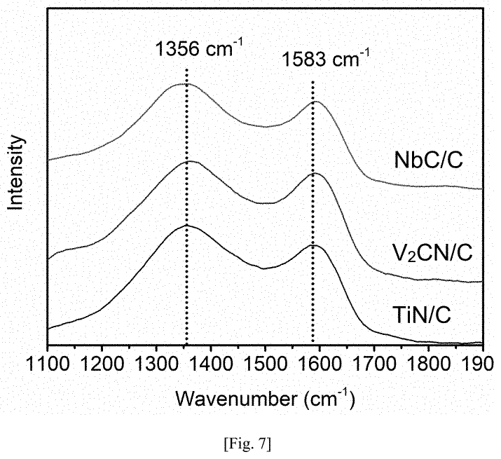

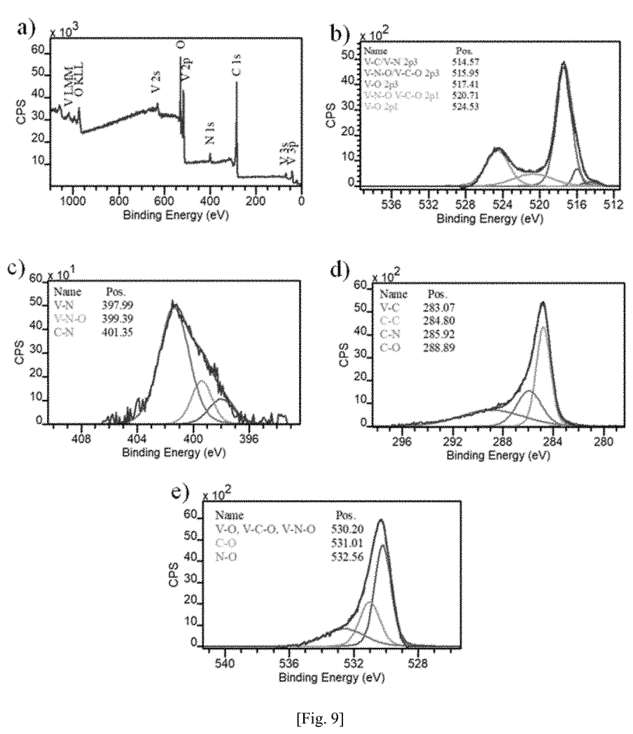

Ti—N bond in TiN/C was confirmed by XPS signals associated with Ti—N in the Ti 2p and N 1s regions at binding energies (BE) of 456.97 (Ti_{2p3/2}) and 396.37 eV, respectively (FIGS. 7b and c). For V₂CN/C, XPS signal at BE of 514.57 eV (V_{2p3/2}) in the V 2p region could be assigned to both V—C and V—N bonds (FIG. 8b). This was corroborated with XPS signals in the N 1s region at a BE of 397.99 for V—N, and in the C 1s region at a BE of 283.07 for V—C(FIGS. 8c and d). For NbC/C, XPS signals at BE of 204.37 eV (Nb_{3d5/2}) and 283.05 eV in the Nb 3d and C 1s regions, respectively, could be assigned to Nb—C bond (FIG. 9 b and d).

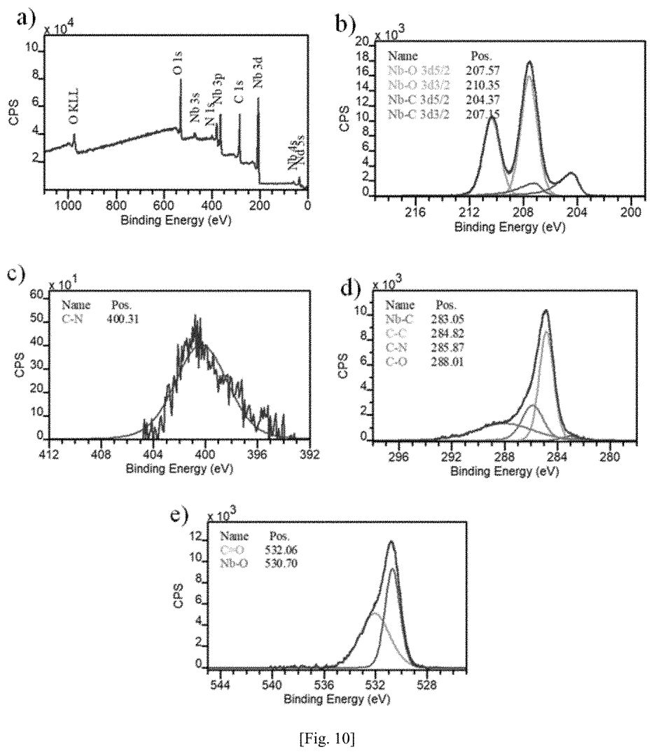

UV-vis spectroscopy and XPS were employed to evaluate the PS adsorption capability of the coral-like nanomaterials (FIG. 5). Li₂S₄ was selected for the study since it was reported to be the main PS in the dioxolane/dimethoxyethane electrolyte system. UV-vis spectrum revealed that the coral-like nanomaterials have reduced absorbance intensity as compared to the initial 2 mM PS curve, indicating PS adsorption (FIG. 5a). Using a calibration curve based on absorbance of standard solutions (FIG. 10), the amounts of Li₂S₄ adsorbed by V₂CN/C, TiN/C and NbC/C were calculated to be 0.198, 0.144 and 0.119 mg/mg, respectively.

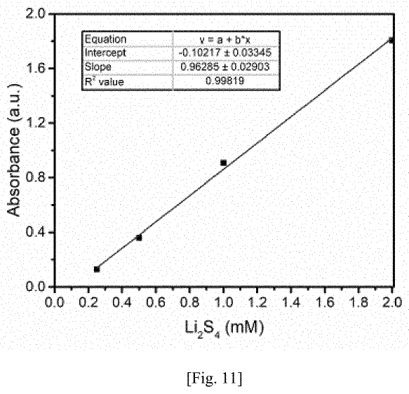

The nature of the adsorption was further studied using XPS. In general, XPS signals in the S 2p region of S corresponding to bridging S (S_{B}), terminal S (S_{T}) and sulfates were present in PS-adsorbed materials. BE of both S_{B} and S_{T} shifted to a higher energy as compared to that of pure Li₂S₄(FIG. 11), implying a decrease in electron density for S. Conversely, a shift to a lower BE was observed for the metal-nitrogen (M-N) (i.e. Ti—N, V—N) and metal-carbon (M-C) (i.e. V—C, Nb—C) signals, indicating an increase in electron density at the metal center, which could be attributed to strong metal-S interactions (FIG. 5b-d). These BE shifts indicated strong chemical interaction of these coral-like nanomaterials with PS. Notably, the shift in BE was more significant for the M-N and M-C bonds than the metal-oxygen (M-O) bonds, suggesting that PS had a higher affinity to M-N and M-C bonds than M-O bond, and that the amorphous M-O layer was thin and labile. In addition, the BE shifts of V—N and V—C in V₂CN/C (0.86 eV) were found to be greater in magnitude as compared to Ti—N and Ti—N—O in TiN/C (0.40 eV) and Nb—C in NbC/C (0.24 eV), suggesting that PS interaction with V₂CN/C was the strongest, followed by TiN/C and NbC/C. A stronger interaction would result in greater bond polarization, leading to a lower activation energy for electrochemical reactions in LSB. Although BE shifts were commonly reported in the literature, such comparison amongst metal compounds at this size range (3 to 4 nm) was not reported previously. Based on the above studies, V₂CN/C was found to have the best PS adsorption ability, followed by TiN/C and NbC/C.

Cyclic Voltammetry (CV) and Electrical Impedance Spectroscopy (EIS)

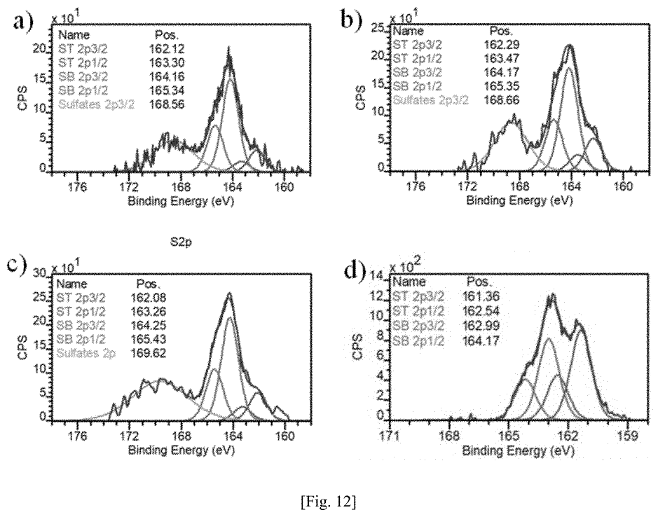

CV curves of batteries containing both modified and unmodified separators revealed features typical of a LSB system: two sharp reduction peaks and a broader oxidation peak (FIG. 12a). These peaks were found to be sharper in batteries with modified separator. The area under the curve, for the modified separators appeared to be larger than that for the unmodified separator, indicating a greater charge storage capacity. In addition, as compared to the unmodified separator, the higher onset reduction potential and lower onset oxidation potential for the modified separator indicated a lower activation energy barrier for the electrochemical reactions in the LSB cells. EIS revealed that the charge transfer resistance (R_{CT}) of the TiN/C, V₂CN/C, NbC modified separator and the unmodified separator were 8.5, 11.4, 11.9 and 40.0, respectively (FIG. 12b). The reduced R_{CT} values after separator modification could be due to the high electrical conductivity of TiN, V₂CN and NbC, which could enhance the surface charge transfer reactions for better electrochemical performance.

Coin Cell Preparation and Electrochemical Testing

Standard 2032-type coin cells were used for cell cycling and rate capability tests. Assembly was done in an argon-filled glovebox, with the 10-mm cathodes and lithium foil as the anode/reference electrode. The electrolyte was prepared by adding 1 M LiTFSI and 2 wt % LiNO₃ to a 1:1 volume mixture of 1,3-dioxolane (DOL) and DME. The modified separators, soaked with electrolyte, were inserted in between the cathode and the anode. Galvanostatic charge-discharge cycling was done using a LAND CT2001 battery tester (Wuhan LAND electronics) between 1.7 V and 2.8 V vs. Li/Li⁺. Cyclic voltammograms were obtained at a scan rate of 0.05 mV s⁻¹, and electrochemical impedance spectra were collected with a 10 mV amplitude at open circuit potential between 1 MHz and 0.01 Hz on an M204 Autolab potentiostat (Metrohm) fitted with a frequency response analyzer module.

Electrochemical Performance

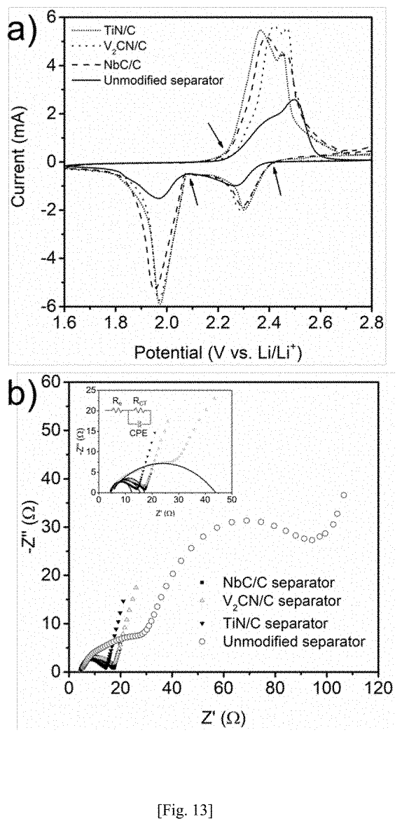

The electrochemical performance of the batteries was evaluated by subjecting them to rate capability tests at different C rates for 5 cycles each, and long-term cycling at a fixed C rate (1 C=1673 mA g⁻¹) over 100 cycles. Rate capability studies showed that the specific discharge capacities of the batteries having separators modified with TiN/C, V₂CN/C and NbC/C were 2.5 times higher than the unmodified control cell at all rates (FIG. 13a, Table 3), corroborating well with the larger area observed for the modified separators from CV analysis mentioned earlier.

TABLE 3
Average specific capacities of the modified
separators at different C rates.

| Separator | 0.1 C | 0.2 C | 0.5 C | 1 C |
|---|---|---|---|---|
| — | 472 | 399 | 119 | 57 |
| TiN/C | 1203 | 1077 | 947 | 822 |
| V₂CN/C | 1107 | 972 | 745 | 693 |
| NbC/C | 1118 | 993 | 823 | 727 |

The discharge curves of voltage versus specific capacity all showed two plateaus typical of LSB: the first plateau (Q_{H}) at a higher voltage of about 2.35 V versus Li, and the second plateau (Q_{L}) at a lower voltage of about 2.05 V versus Li (FIG. 13b). The overall specific capacity of LSB was determined to be the summation of the capacity contribution from Q_{H} and Q_{L}, associated with sulfur dissolution to soluble PS and its subsequent reduction to insoluble Li₂S or Li₂S₂, respectively. Both Q_{H} and Q_{L} capacities were found to be larger for the modified separators due to the availability of the large surface areas and redox-active sites of TiN/C, V₂CN/C and NbC/C for facile sulfur dissolution into PS and subsequent PS reduction to insoluble sulfides (FIG. 5b, Table 1).

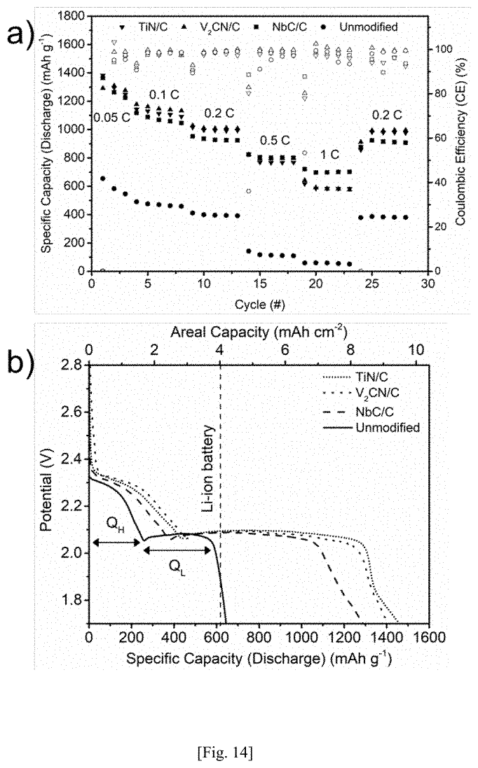

Amongst the modified separators, the highest specific capacity was obtained for the TiN/C material, followed by NbC/C and V₂CN/C at all rates based on the rate capability studies (FIG. 12b, Table 2). To determine if these high capacities could be sustained for repeated charge and discharge cycles, long-term cycling studies were conducted at 0.2 C. At 0.2 C, the initial specific discharge capacities of separator modified with TiN/C, V₂CN/C and NbC/C and the unmodified separator were 1051, 963, 921, 401 mAh g⁻¹ (FIG. 14a), corresponding to areal capacities of 6.73, 6.35, 5.99, 2.65 mAh cm⁻², respectively (FIG. 14b). After 100 cycles, specific discharge capacities of 853, 877, 719, 294 mAh g⁻¹, corresponding to areal capacities of 5.46, 5.79, 4.67, 1.94 mAh cm⁻², were retained for separator modified with TiN/C, V₂CN/C and NbC/C and the unmodified separator, respectively.

The areal capacities obtained using the separators modified with the coral-like nanomaterials exceeded that of current LIBs (4 mAh cm⁻²) even after 100 cycles, indicating their great potential as practical, high loading LSB. Capacity retention at 0.2 C was found to be the highest for V₂CN/C (91.1%), followed by TiN/C (81.2%), NbC/C (78.1%) and unmodified separator (73.3%). Although the separator modified with the V₂CN/C material had the lowest capacity, its ability to retain capacity, a serious issue in high loading cathodes in LSB, was superior as compared to TiN/C and NbC/C. Using the Q_{H} values extracted from the discharge curves, a quantitative assessment on the PS-trapping ability (Q_{H} retention) of each separator, could be obtained. The relative Q_{H} retention for V₂CN/C, TiN/C and NbC/C were 73.3%, 70.8% and 69.6%, respectively (FIG. 14c). Thus, V₂CN/C has the best PS adsorption capability, followed by TiN/C and NbC/C, agreeing well with the PS adsorption studies conducted with UVS and XPS.

The use of conductive and highly dispersed nanoparticles of TiN, V₂CN and NbC on a coral-like carbon structure have been demonstrated here as an effective PS barrier for high loading LSB. V₂CN/C-modified separator was found to have the highest reversible specific capacity and capacity retention of 877 mAh g⁻¹ (5.79 mAh cm⁻²) and 91.1%, respectively, after 100 cycles at 0.2 C. This could be attributed to its superior PS adorption capability as shown by UVS, XPS and Q_{H} analysis studies. Although reversible capacities and capacity retention were found to be lower for TiN/C (853 mAh g⁻¹ and 81.2%) and NbC/C (719 mAh g⁻¹ and 78.1%), their areal capacities of 5.46 and 4.67 mAh cm⁻², respectively, were still higher than 4 mAh cm⁻²—a value obtained by current state-of-the-art LIBs. As such, the design and construction of an effective PS barrier that has high PS adsorption and binding capabilities as demonstrated here, are parameters required to overcome the current limitations of LSB with high sulfur loadings.

### INDUSTRIAL APPLICABILITY

In the present disclosure, the coral-like composite material, the coating material may be used for a modified separator of a lithium-sulfur battery with practical and high areal capacity. The design strategy of optimizing polysulfide adsorption via the use of novel highly dispersed and conductive nanoparticles on a high surface area, coral-like carbon matrix for separator modification represents an effective method to suppress polysulfide shuttling and improve electrochemical performance of lithium-sulfur battery with high sulfur loading.

It will be apparent that various other modifications and adaptations of the invention will be apparent to the person skilled in the art after reading the foregoing disclosure without departing from the spirit and scope of the invention and it is intended that all such modifications and adaptations come within the scope of the appended claims.

1. A coral-like composite material comprising highly dispersed conductive metal nitride, metal carbide or metal carbonitride nanoparticles on mesoporous carbon nanosheets.

2. The coral-like composite material of claim 1, wherein the size of the metal nitride, metal carbide or metal carbonitride nanoparticles is in the range of about 2 nm to about 20 nm.

3. The coral-like composite material of claim 1, wherein the metal element from the metal nitride, metal carbide or metal carbonitride nanoparticles is scandium, titanium, vanadium, chromium, manganese, iron, cobalt, nickel, copper, zinc, yttrium, zirconium, niobium, molybdenum, technetium, ruthenium, rhodium, palladium, silver, cadmium, hafnium, tantalum, tungsten, rhenium, osmium, iridium, platinum, or their combinations thereof.

4. The coral-like composite material of claim 1, wherein the metal carbide is niobium carbide, titanium carbide, tungsten carbide, molybdenum carbide, vanadium carbide, hafnium carbide, niobium titanium carbide, chromium carbide, niobium tungsten carbide, niobium molybdenum carbide, niobium vanadium carbide, niobium hafnium carbide, titanium tungsten carbide, titanium molybdenum carbide, titanium vanadium carbide, titanium vanadium chromium carbide, titanium hafnium carbide, tungsten molybdenum carbide, tungsten vanadium carbide, tungsten hafnium carbide, molybdenum vanadium carbide, molybdenum hafnium carbide, vanadium hafnium carbide or their mixtures thereof.

5. The coral-like composite material of claim 1, wherein the metal nitride is titanium nitride, tungsten nitride, molybdenum nitride, vanadium nitride, niobium nitride, zirconium nitride, hafnium nitride, titanium tungsten nitride, titanium molybdenum nitride, titanium vanadium nitride, titanium niobium nitride, titanium vanadium chromium nitride, titanium zirconium nitride, titanium hafnium nitride, titanium chromium nitride, tungsten molybdenum nitride, tungsten vanadium nitride, tungsten niobium nitride, tungsten zirconium nitride, tungsten hafnium nitride, molybdenum vanadium nitride, molybdenum niobium nitride, molybdenum zirconium nitride, molybdenum hafnium nitride, vanadium chromium nitride, vanadium niobium nitride, vanadium zirconium nitride, vanadium hafnium nitride, niobium zirconium nitride, niobium hafnium nitride, zirconium hafnium nitride or their mixtures thereof.

6. The coral-like composite material of claim 1, wherein the metal carbonitride is vanadium carbonitride, titanium carbonitride, titanium vanadium chromium carbonitride, tungsten carbonitride, molybdenum carbonitride, niobium carbonitride, zirconium carbonitride, vanadium titanium carbonitride, vanadium chromium carbonitride, vanadium tungsten carbonitride, vanadium molybdenum carbonitride, vanadium niobium carbonitride, vanadium zirconium carbonitride, titanium tungsten carbonitride, titanium molybdenum carbonitride, titanium niobium carbonitride, titanium zirconium carbonitride, tungsten molybdenum carbonitride, tungsten niobium carbonitride, tungsten zirconium carbonitride, molybdenum niobium carbonitride, molybdenum zirconium carbonitride, niobium zirconium carbonitride or their mixtures thereof.

7. The coral-like composite material of claim 1, wherein the metal carbide, metal nitride or metal carbonitride nanoparticles further comprises surface metal oxides.

8. The coral-like composite material of am claim 1, wherein the coral-like composite material has:
a) a surface area larger than 100 m²/g;
b) a pore volume in the range of about 0.5 cm³/g to about 2 cm³/g; or
c) a pore size in the range of about 2 nm to about 50 nm.

9. (canceled)

10. (canceled)

11. A method for preparing a coral-like composite material comprising the steps of
a) mixing a mixture of a precursor of metal nitride, metal carbide or metal carbonitride material and a graphitic carbon nitride material; and
b) drying the mixture and heating solids obtained from dried mixture at a first elevated temperature for a first time period and at a second elevated temperature for a second time period in an inert atmosphere.

12. The method of claim 11, wherein the precursor of the metal nitride metal carbide or metal carbonitride material is a transition metal alkoxide, a transition metal acetylacetonate or a transition metal chloride.

13. The method of claim 11, wherein the first elevated temperature of step b) is in the range of about 400° C. to about 700° C. and the first time period of step b) is more than 3 hours.

14. The method of claim 11, wherein the second elevated temperature of step b) is in the range of about 750° C. to about 1000° C. and the second time period of step b) is more than 2 hours.

15. A coating material for a modified separator of a lithium-sulfur battery comprising a coral-like composite material, a conducting carbon material and a binder, the coral-like composite material comprising highly dispersed conductive metal nitride, metal carbide or metal carbonitride nanoparticles on mesoporous carbon nanosheets.

16. The coating material of claim 15, wherein the conducting carbon material is selected from the group consisting of reduced graphene oxide, graphene, graphite, carbon nanotube, carbon fiber, acetylene black, and ketjenblack.

17. The coating material of claim 15, wherein the conducting carbon material has a diameter in the range of about 0.1 nm to about 100 μm.

18. The coating material of claim 15, wherein the coating material has a thickness in the range of about 5 μm to about 70 μm, or wherein the coating material has a mass density in the range of about 0.5 mg cm⁻² to about 3 mg cm⁻².

19. (canceled)

20. A method for preparing a modified separator for lithium-sulfur battery comprising the steps of
a) mixing a mixture of a coral-like composite material, a conducting carbon material and a binder, wherein the coral-like composite material comprises highly dispersed conductive metal nitride, metal carbide or metal carbonitride nanoparticles on mesoporous carbon nanosheets; and
b) coating the mixture on a porous and non-electrically-conductive membrane.

21. The method of claim 20, wherein the conducting carbon material is selected from the group consisting of reduced graphene oxide, graphene, graphite, carbon nanotube, carbon fiber, acetylene black, and ketjenblack.

22. The method of claim 20, wherein the porous and non-electrically-conductive membrane is a glass fiber membrane, a polypropylene and/or a polyethylene electrolytic membrane.

23. A lithium-sulfur battery comprising a coating material for a modified separator of a lithium-sulfur battery comprising a coral-like composite material, a conducting carbon material and a binder, the coral-like composite material comprising highly dispersed conductive metal nitride, metal carbide or metal carbonitride nanoparticles on mesoporous carbon nanosheets.
